(19) United States
(12) Patent Application Publication
(10) Pub. No.: US 2019/0208718 A1
(43) Pub. Date: Jul. 11, 2019

(54) Composite structure and a method for producing the same

(71) Applicant: KEKKILA OY, Vantaa (FI)

(72) Inventors: Kari Silokangas, Hämeenlinna (FI); Jorma Kautto, Vantaa (FI); Janne Kangas, Helsinki (FI)

(21) Appl. No.: 16/328,297

(22) PCT Filed: Aug. 25, 2017
(86) PCT No.: PCT/FI2017/050599

§ 371 Date: Feb. 26, 2019

(30) Foreign Application Priority Data
Aug. 26, 2016 (FI) 20165637

(51) Int. Cl. A01G 24/28; A01G 24/30; A01G 24/44

(52) U.S. Cl. CPC A01G 24/28; G10K 11/162; A01G 24/44; A01G 24/30

(57) ABSTRACT

According to the present invention a composite structure is provided comprising in intimate mixture essentially through the whole composite structure: peat fibers, peat particles, peat agglomerates or mixtures thereof, that have been obtained from horticultural peat by fractionation or by producing from peat fines; and polymer fibers, which composite structure has been heat-treated to bind the polymer fibers to each other and to stabilize the peat fibers, peat particles, peat agglomerates or mixtures thereof in place in the composite structure. In addition, a process is provided for the production of the composite structure.

### FIELD OF THE INVENTION

The present invention relates to composite structures comprising peat, in particular to growth media and insulating boards.

### STATE OF THE ART

In professional greenhouse cultivation, use is currently made mainly of peat-based or mineral wool-based growth media. The growth media in vegetable cultivation are typically products that are limited in size and sheet-like, with the intention to enable the supply of water and nutrients for the plants by providing the root system of the crop with an optimum surface for growth and adhesion and by functioning as nutrient and water supply during the cultivation. As far as effectivity of growth and functioning are concerned, structural composition of the growth medium has precise requirements, for example regarding its porosity. With irrigation water the plant is supplied with the right amount of nutrients for efficient growth as well as for the needs of a high-quality and abundant crop yield. An optimal growth medium serves as the plant's nutrient and water buffer during cultivation, whereby excessive over-irrigation is not needed and unnecessary washout of nutrients will not take place. This way all nutrients are efficiently rendered available for use by the plant, and the possible loss of nutrients and water remains as small as possible. In addition, a good growth medium prevents the emergence and spreading of plant diseases. The used growth medium should be easily recyclable for beneficial use after cultivation. Typically, almost all tomatoes, cucumbers, peppers, salads and herbs sold in stores are grown in industrially produced growth media.

Good qualities of peat-based growth media include their excellent water and nutrient retention capacity, affordability, natural character, recyclability after use, and intrinsic microbial activity that promotes growth and prevents diseases. Their disadvantages include poor handling in automated systems, compression of structure in long-term cultivation and the general anti-peat opinion in some market areas. Handling of bulk peat is often manual labor. In addition to bulk peat, peat-based growth media are frequently compressed into sheets that are more easily handled and transported. Due to their fragility, peat sheets are, however, unsuitable for automated handling, and cannot be used cost-efficiently for producing sowing or seedling cubes suitable for mechanical seedling production.

The advantage of glass wool/mineral wool type growth media is their suitability for highly automated seedling production and cultivation. Due to their inactivity, they are well suited for e.g. the so-called recirculating aquaculture. The disadvantage of inactive substrates is their poor water and nutrient retention capacity, which means that nutrients and water will be abundantly wasted during cultivation. A disadvantage is also their disposal after use: mineral wool cannot be burned or composted. In addition, mineral wool does not contain natural, growth-promoting beneficial micro-organisms.

Greenhouse cultivation is currently pursuing high production efficiency, which signifies automating of production at all stages. Typically, production with a high degree of automation is needed in the cultivation of the so-called bulk vegetables such as tomato, cucumber and lettuce.

In tomato and cucumber cultivation, the seeds are sown into a so-called sowing cube, for example about 3 cm×3 cm×4 cm in size, present in a larger backing board. The backing board accommodating e.g. 150 sowing cubes enables a more efficient handling of sowing cubes. The seeds are sown into the sowing cubes by using an automated seeding machine, and the sowing cubes are then, still in the backing boards, taken into a separate germination room. In the germination room optimal conditions can be arranged for rapid and steady germination of the seed. In order to be mechanically processed, a sowing cube must be made of a sufficiently strong material. Sowing cubes made of bulk peat or compressed peat sheet are with some limitations suitable for this purpose.

After this, upon germination of the seed, it is transferred for the actual seedling cultivation into the so-called seedling cube. A seedling cube is a piece of growth medium, typically approx. 10 cm×10 cm×6 cm in size, having a planting hole which will accommodate the sowing cube. The seedling cubes are spread and thinned out onto seedling cultivation tables in a greenhouse. All of these operations can be carried out by using automation. In the greenhouse, seedlings growing in the seedling cube are being fertilized, watered and maintained under suitable conditions of temperature and illumination. After the seedling cultivation step, when the seedlings have grown into the correct size and well rooted into the seedling cube, they are ready to be delivered to the grower, to be planted into their actual production medium.

The bottom of a seedling cube typically has grooves with the purpose of ensuring free transfer of nutrient solution under the cube during seedling cultivation and thus securing optimal development of the root system. The second function of the grooves is to reduce the area in contact with the nutrient solution in order to prevent suffocation of the roots in excessive irrigation water. In addition, the edges of the seedling cube comprise a separating layer of e.g. plastic, designed to prevent rooting of the cubes with each other before thinning out during seedling cultivation.

The actual production growth medium is a sheet-like board of peat or mineral wool, typically packed in a plastic bag. The surface of the bag has pre-cut holes for the seedling cubes. In the greenhouse after planting of the seedlings, a drip irrigation nozzle for supplying water and nutrients will be inserted into the surface of the seedling cube planted onto the cultivation board.

Cultivation of lettuce can be carried out by delivering the lettuces and herbs to the shop either in their growth medium or without the medium. In the case of products including the growth medium, the peat will be put into a plastic pot enabling its automated handling during cultivation. When lettuce is delivered without the growth medium, cut and packed into a closed bag, it can also be planted and grown in long growth medium boards that can successfully be handled with automated equipment.

In order for the above-mentioned automated handlings to be possible, the growth media must be sufficiently firm and capable of being processed into a form suitable for automated equipment. In this respect, a growth medium made of mineral wool is currently superior at all cultivation stages described above. The use of bulk peat in automated equipment is difficult and the sheets compressed from bulk peat are too fragile to be processed with automated equipment.

On the other hand, peat growth medium has many properties that are, for example, better in terms of the plant's health, production and environment than in mineral wool. In order to be able to combine the good growth medium properties of peat and the manageability of mineral wool, a superior product for greenhouse production could be created.

As far as usability is concerned, all growth medium materials in the production chain should be compatible and preferably of the same material. This will also facilitate the recycling and disposal of used media.

Methods of production are known in the market by which insulating materials can be produced from natural fibers or recycled fibers and polyester (PES) bi-component fiber (e.g. www.angleitner-doa.at).

Peat has been used not only in growth media but also in other composite structures, such as, for example, for the production of various insulation boards, acoustic panels (www.konto.fi) and non-woven. A typical feature of these solutions is that peat is not fractionated to better suit its intended purpose, but use is rather made of peat purified from impurities as such.

Disclosed in publication FI 122883 (B) is the production of a compression moulding from peat and polyester. Publication US 20090019765 describes a growth medium comprising heat-activable binder fibers allowing addition of a conventional, natural growth medium such as peat or sand.

Disclosed in publication WO 2008065233 (A1) is an oil absorbent structure made of peat and polyester.

Disclosed in publication FI 10169 (U1) is a water retention layer consisting of bulk peat and urea-aldehyde polymer foam.

### BRIEF DESCRIPTION OF THE INVENTION

The invention is defined in the independent patent claims. Preferred embodiments are defined in the dependent patent claims.

According to an aspect of the invention a composite structure is provided comprising in intimate mixture essentially through the whole composite structure: peat fibers, peat particles, peat agglomerates or mixtures thereof, that have been obtained from horticultural peat by fractionation or by producing from peat fines; and polymer fibers, which composite structure has been heat-treated to bind the polymer fibers to each other and to stabilize the peat fibers, peat particles, peat agglomerates or mixtures thereof in place in the composite structure.

According to another aspect of the invention a process is provided for the production of a composite structure by air-laid forming, in which process: a mixture is formed comprising in intimate mixture peat fibers, peat particles, peat agglomerates or mixtures thereof and polymer fibers; the mixture is spread as a layer on a screen; and the layer heat-treated to bind the polymer fibers to each other and to stabilize the peat fibers, peat particles, peat agglomerates or mixtures thereof in place.

### BRIEF DESCRIPTION OF THE DRAWINGS

FIG. 1 shows commercial sowing cubes made of mineral wool in a backing board.

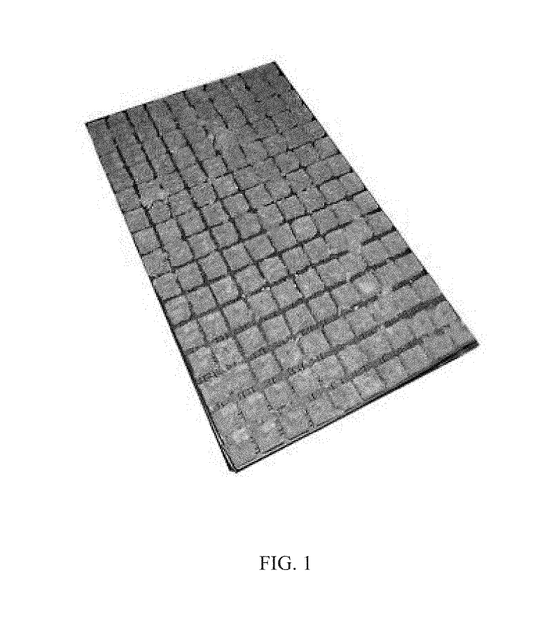

FIG. 2 shows a seedling cube made of peat fiber composite according to an embodiment of the present invention.

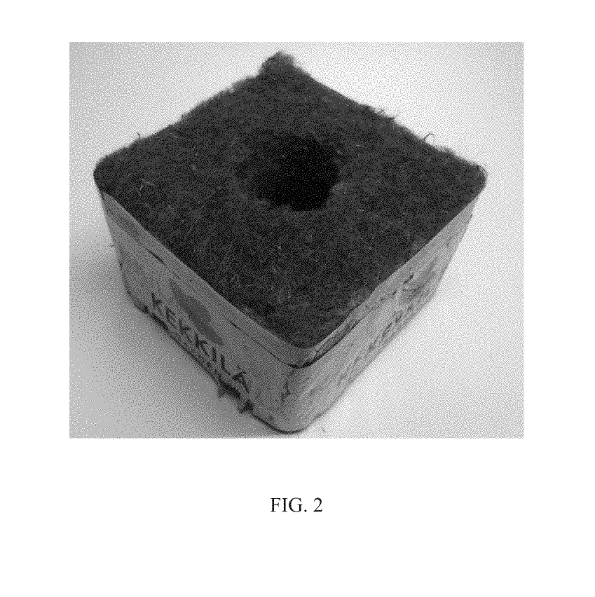

FIGS. 3A and 3B show commercial growth medium boards. 3A is a board made of mineral wool and 3B is a board made of compressed peat and packed in a plastic bag.

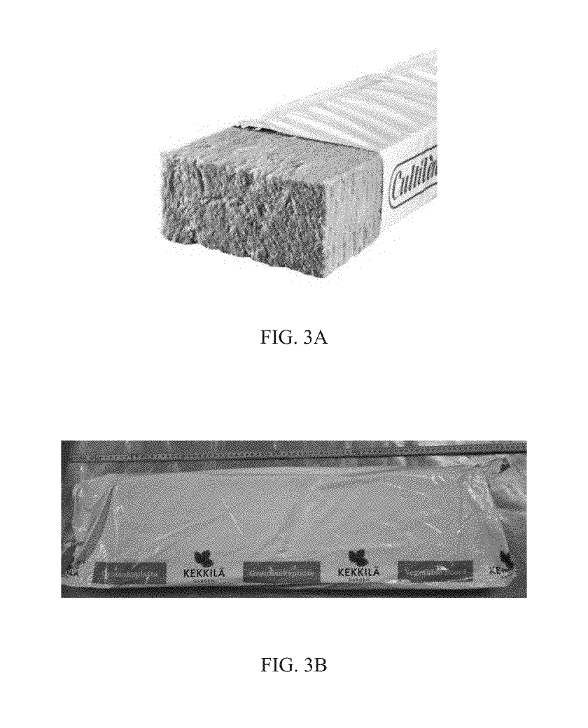

FIG. 4 shows long peat fibers according to an embodiment of the present invention.

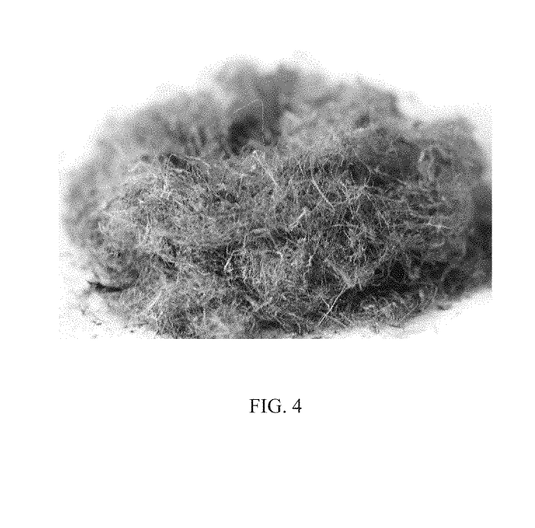

FIG. 5 shows peat fiber composite wool according to an embodiment of the present invention.

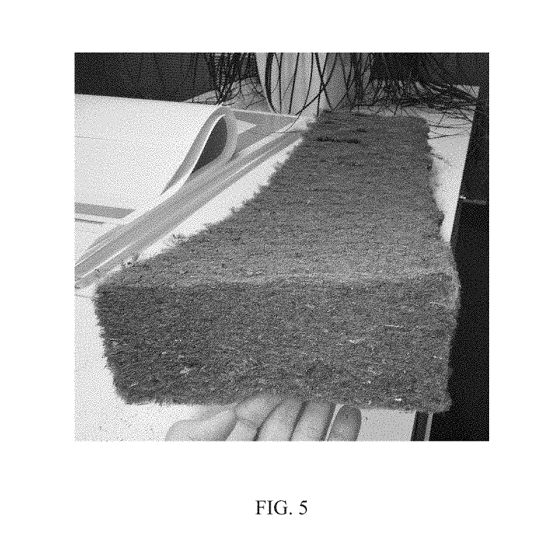

FIG. 6 shows tomato seedlings in a peat fiber composite seedling cube according to an embodiment of the present invention.

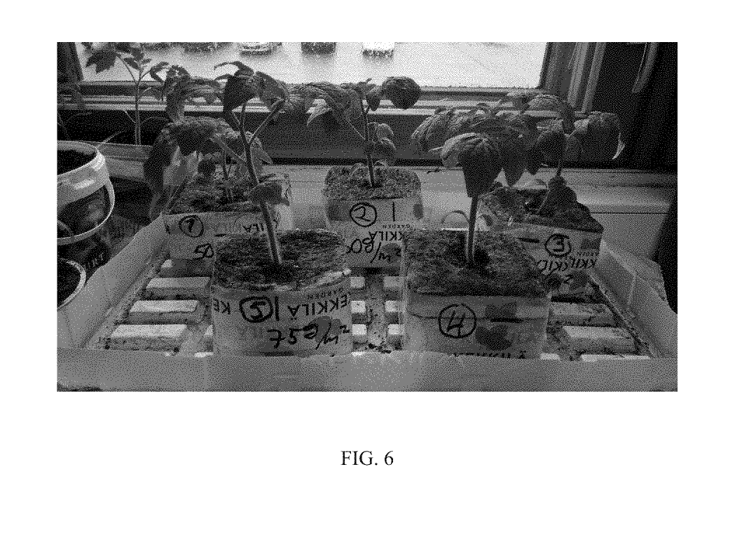

FIG. 7 shows a production growth medium produced from peat fiber composite wool according to an embodiment of the present invention, comprising commercial seedling cubes made of mineral wool. In FIG. 7, tomato production is in progress and a well-developed root system of tomato is seen in the picture.

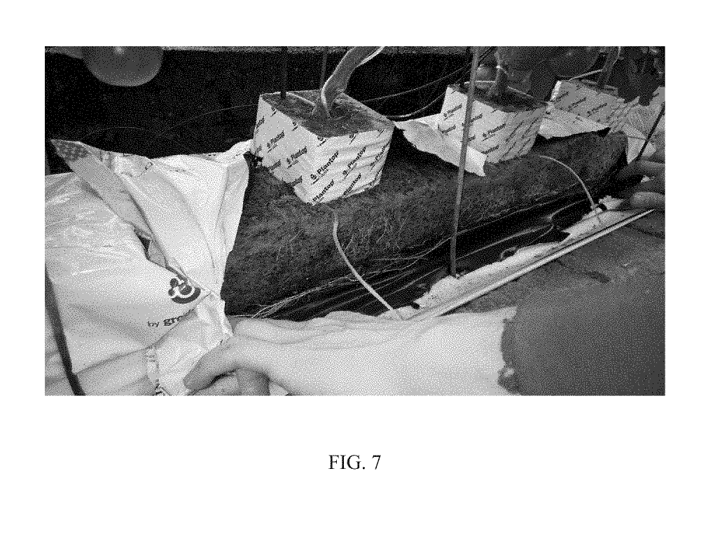

### DETAILED DESCRIPTION OF THE INVENTION

Peat is mass of plant origin that also contains fibrous fractions. These fractions can be isolated by various fractionation methods. Peat fibers can be isolated as fractions of varying length: the longest fibers are several tens of millimeters in length. In addition, there are other particles and agglomerates present in peat, typically having a size of 1 to 20 mm. It has been found in the present invention that it is possible to prepare fractions from peat that are particularly well suited for the production of a composite structure together with polymer fibers functioning as binder fibers. Such composite structures are suitable e.g. for use in growth media being handled with automated production equipment, or as thermal or acoustic insulators.

In a preferred embodiment a porous composite structure according to the invention has been produced by air-laid forming as follows: a mixture is formed comprising in intimate mixture peat fibers, peat particles, peat agglomerates or mixtures thereof and polymer fibers; the mixture is spread as a layer on a screen; and the layer heat-treated to bind the polymer fibers to each other and to stabilize the peat fibers, peat particles, peat agglomerates or mixtures thereof in place, whereby a finished, sheet-like composite structure is obtained.

It is possible that peat fibers, peat particles or peat agglomerates adhere to the polymer fibers upon heat treatment, or they can alternatively become mechanically stabilized into the porous polymer structure. Both mechanisms are also possible.

The screen can be for instance a plastic or metal screen of other web-like structure that is suitable for running the mixture in the process according to the invention.

The mixture can be formed for instance by dry mixing or some other suitable mixing method.

For successful heat treatment the peat fibers, peat particles, peat agglomerates or mixtures thereof must be dried to suitable moisture content prior to the production process, typically to 10 to 30%.

In some embodiments the composite structure comprises coarse peat material consisting of peat fibers, peat particles, peat agglomerates or mixtures thereof that have been obtained either by fractionation from horticultural peat or producing from peat fines. For instance, peat agglomerates of desired size can be produced from fine fractions of peat by using a suitable binder.

“Agglomerates” refer to particles and/or fibers that are attached to each other forming bodies that are larger in size than their constituent units.

It is particularly preferred that the peat fibers, peat particles, and peat agglomerates in the composite structure are large enough to stay in place within the polymer fiber structure and are not detached from it in significant amounts during the production process or further processing of the product. Detachment signifies mass loss and dusting of the product.

The more polymer fibers are present in relation to peat particles, the denser the polymer network of the structure will become and the better it will hold peat particles in place in the structure. If minimizing the amount of polymer fibers in the product is desired, the polymer network becomes less dense, whereby the size of peat fibers, peat particles fractionated into a desired size, or peat agglomerates must be increased proportionately and the amount of peat fines in the raw material decreased.

In at least some embodiments of the present invention a composite structure has been achieved in which the coarse peat material is stabilized in place so that no more than 1% of the peat material is detached from the structure as a result of being subjected to gravity or normal further processing of the product.

In addition to peat fibers, other natural fibers of suitable length can be used in the structure, for example moss, cellulose, carbon, wood fiber, flax, reed canary grass, coconut fiber or hemp fiber. These additional fibers enable fine-tuning of the product's properties to be suited for certain plants or different cultivation methods. For instance, addition of moss improves the water absorption capacity of the product. Adding hemp or coconut fiber will again strengthen the structure of the medium and affects its porosity.

According to an embodiment the composite structure has been heat-treated at a temperature in which the selected polymer fibers adhere to each other as a consequence of the polymer itself or another adhesive present on the surface of the fiber.

According to an embodiment the polymer fiber is a bi-component PES fiber. This is a two-layer fiber having a rigid core with higher heat resistance and on its surface a plastic material melting/softening at a lower temperature. During the heat treatment the temperature is preferably raised to a maximum temperature at which the surface layers of the fiber will adhere to each other while the more rigid core of the fiber will not markedly react to heating.

In one embodiment another bi-component plastic fiber or other similar plastic fiber that is preferably biodegradable or compostable, is used instead of the bi-component PES fiber, whereby the growth medium will be even friendlier to the environment.

It has been found in the invention that peat fibers can be used to replace other natural fibers or recycled paper fibers or at least part of them, and still achieve a composite structure having similar or better properties and serving as an insulator or growth medium, for example.

It has been found in the invention that the composite structure is well suited for the production of production growth media, sowing cubes and seedling cubes. As far as manufacturing technology is concerned, the products differ from each other mainly in their density, thickness and the amount of additives.

In the growing experiments performed, tomato seedlings have, among other things, grown in the structure according to the invention at least as well as in a commercial reference product.

The size, density and porosity of the structure, such as a board according to the invention, can be modified, whereby the correct growth conditions can be found for the root system of the plants by altering the production parameters and raw material composition of the structure.

According to an embodiment, the average porosity and/or pore size of the structure according to the invention is essentially uniform throughout the whole structure. It is preferable that the structure is homogenous with regard to porosity and/or density and that the fibers have mixed with each other through the whole structure, in an unstructured manner, whereby the polymer fibers can effectively support the peat material.

Preferably there is no stratification or separate layer of peat or polymer in the composite structure. Non-stratification means that both the peat fibers and the polymer fibers are distributed evenly in the structure and the structure possesses a homogenous composition. An advantage is that the polymer fibers are able to support the structure to a desired volume and porosity and prevent the structure from collapsing. Upon decomposing, peat material that is separated from the polymer fibers would collapse, resulting in a reduction of the sheet's porosity, and its functionality as growth medium would decrease.

“Porosity” refers to the ratio of the total volume of non-solid material (pores and fluid) to the total volume of the material (solid and non-solid).

The growth medium material according to the invention can be used for growing for example the following plants in greenhouses or plastic tunnels tomato, cucumber, pepper, lettuce, herbs and strawberry.

Since the main raw material of the sheet is based on horticultural peat, it defines the product's growth medium properties close to those of conventional horticultural peat, being, however, in its mechanical properties comparable to mineral wool growth media. Accordingly, the beneficial aspects of horticultural peat and mineral wool as growth medium are combined in the solution.

According to an embodiment the proportion of polymer fibers in the mixture spread onto the screen is from 5 to 50 wt-%, preferably from 10 to 20 wt-%.

According to an embodiment, peat fiberboard can be produced by mixing peat fiber and bi-component PES fiber with each other in a suitable ratio. In the performed test runs it has been found that the amount of PES fiber in the mixture to be spread onto the screen is preferably from 5 to 50 wt-%, most preferably from 10 to 20 wt-%.

In one embodiment the length of peat fiber, size of peat particles or size of peat agglomerates are selected so that it will function in production as well as possible. The peat material used in production preferably comprises at least 10%, for instance at least 20% of peat fibers or peat agglomerates, having a length of at least 8 mm. Peat-based ingredients will then remain well attached to the polymer fiber matrix generated during the production process.

The process also allows the addition of other fibers or materials to the board. For instance pulp fiber, carbon, wood fiber, flax, reed canary grass, moss, grass fiber or other natural fibers can be used. In this way, growth media can be produced on the market where the use of peat is not primarily desired in growth media, or if the product is intended to be provided with specific properties for certain plants.

According to an embodiment the growth medium comprises 80 to 90%, for example approx. 85% of peat fiber of the dry weight of the growth medium, the remainder being polymer fiber.

According to an embodiment the polymer fiber is a thermoplastic polymer fiber.

According to an embodiment the polymer fiber is bi-component PES fiber.

The advantage of this embodiment is that the growth medium can be completely demolished by combusting.

According to an embodiment the polymer fiber is a compostable polymer fiber which is degraded into nutrients, or a biodegradable polymer fiber, the polymers of which are broken down into smaller units by the action of bacteria and fungi. The advantage of this embodiment is that the growth medium can be disposed of by composting.

According to an embodiment the polymer fiber is PLA or PHA or some other biodegradable plastic or derivative thereof.

According to an embodiment the length of the polymer fibers is from 10 to 50 mm.

According to an embodiment the growth medium does not contain recycled paper fiber. Recycled paper contains printing ink chemicals and papermaking chemicals, which may end up in food-producing plants and affect e.g. the acidity of the growth medium thereby hampering its cultivation properties. Furthermore, cellulose fiber is prone to moulding upon getting damp, which increases the risks of plant disease and may bring about a risk of exposure for horticultural workers.

According to an embodiment the density of the growth medium is from 30 to 120 kg/m³.

According to an embodiment, prior to heat treatment, one or more of the following are added to the peat fibers, peat particles, peat agglomerates, polymer fibers, mixture and/or layer: wetting agent, fertilizer, humic acid, lime.

### EXAMPLES

### Example 1

In the following an exemplary process for the production of a heat and sound insulation board as well as an acoustic board is described. By mixing peat fibers and other natural fibers and the bi-component PES fiber together in a suitable ratio and forming, by using transport air of the fibers, a layer of uniform thickness onto a screen (so-called air-laid-forming) and heat-treating the layer on the screen (so-called thermo bonding), insulating wool is formed. The temperature used at the heat treatment stage is dependent on the plastic fiber used and may for instance be in the range of 150° C. to 200° C., for example about 160° C. It is typical for such insulating wool that the surface layer of the bi-component PES fiber has bound the fibers together and the rigid core makes the board elastic and structurally stable. The PES fiber matrix binds to itself also the other fibers added to the layer, whereby the final result is a board that is sufficiently durable and porous and well able to insulate heat/sound. At a suitable stage of production, one or both sides of the board can be sprayed with flame retardant chemicals, for example boric acid, in order to improve the flame retardant level of the insulator. Thickness of the insulating board is typically from 30 to 100 kg/m³, more preferably from 30 to 50 kg/m³. After the production process, the board can be cut into dimensions conforming to building standards, for example to size 565 mm×870 mm, whereby it is suitable for fitting into k600 and k900 frame structure slots. The thickness of heat insulating boards is typically 50 mm, 75 mm, 100 mm or 150 mm, but can be manufactured to other thicknesses as well.

### Example 2

In the following an exemplary process for the production of a growth medium is described. A mixture of peat fibers and PES fiber is first formed. When necessary, the PES fiber bundles are carded open. Upon forming the fiber mixture, a layer having a desired thickness is formed therefrom onto a screen, for example by the above-mentioned air-laid-forming technique. The process is thus a continuous one. The layer is taken with the screen into an oven, where there is a screen on both sides of the web. The oven has a desired temperature profile in the longitudinal direction, bringing the outer surface of the PES fiber to a suitable bonding temperature (the thermo bonding stage). For some commercial bi-component PES fibers the desired final temperature is about 150° C. By using the screens to compress the layer, the board is brought to the desired thickness and density. The end section of the oven comprises a cooling section, in which the layer keeps its form. Thickness of the growth medium material is typically from 50 to 120 kg/m³, most preferably from 60 to 100 kg/m³, providing the structure with an optimal density for the movement of water and nutrients in the growth medium and consequently for the development of the root system of the plants. Manufacturing technology can be applied to fine-tune the density of the product suitable for each plant species. Typical thickness of the growth medium is from 20 to 200 mm, preferably from 50 to 120 mm.

Before oven, the product may be sprayed with wetting agents in order to accelerate wetting of the final product in the greenhouse, fertilizers or humic acids. Liming of the growth medium can be carried out e.g. by pre-mixing lime to one of the fiber components, for example peat fiber. These steps may be necessary for adjusting the properties of the growth medium.

Following exit from the oven, the web is cut to the desired width and length according to the application. The width of production growth media is typically about 200 mm, whereby it is preferable that the board be cut longitudinally on the board line directly to this size or multiple thereof, e.g. to 600 mm.

The boards can be further processed by repressing, which allows the board's thickness, density, surface quality and shape to be adjusted. Repressing must be carried out with heat in order to maintain the board at the desired thickness after pressing.

The surface of the board may also be attached with fabric or gossamer tissue, with the aim of decreasing dusting of the surface. The surface material attaches to the surface of the board heat thermally, and the outer layer of PES acts as adhesive. The surface of the board may be sprayed with suitable binders, for example starch glue, latex or PVA in order to decrease dusting of the surface.

### Example 3

The length distribution of peat fiber varies depending on where the peat was produced, which kind of conditions the peat has been exposed to, and what is the degree of decomposition of the peat. Shown in Table 1 are typical size distributions of stock peat (as percentages by weight), from which the fractionation of peat fiber and particles is performed. Stock peat refers to peat collected from a peat production area, dried to a moisture content of from 45 to 50% at the peat field and collected to storage heaps i.e. stacks for subsequent use. The storage stacks are covered with plastic to avoid getting wet. Raw material can be removed from the stacks also during winter, which would not be possible directly from peat production areas under Finnish climate conditions: the areas are frozen and covered with snow. Drying performed in the peat field also facilitates transporting, further processing and improves the preservation of peat. Depending on the above-mentioned conditions, the proportion of each individual peat fraction may vary in the range of 0 to 70%, typically 10 to 50%.

TABLE 1

| | Fraction size | | | | |
|---|---|---|---|---|---|
| | 0-1 mm | 1-4 mm | 4-8 mm | 8-16 mm | >16 mm |
| Stack 1 | 15% | 35% | 13% | 22% | 15% |
| Stack 2 | 29% | 47% | 8% | 12% | 4% |
| Stack 3 | 15% | 26% | 10% | 20% | 29% |

The peat grade best suited for each product is selected according to the type of peatland, degree of decomposition and properties of commodity in each stack.

### Example 4

The sheet-like composite structure according to Example 1 has been found to perform well also in oil absorption. It is well known that, upon drying, peat is an effective oil-absorbing material and able to retain certain oil grades even 10 times its own weight. The structure according to Example 1 is capable of retaining oils and can thus be used in oil spill responses. As a sheet-like or rollable material it can easily be spread for oil absorbing and the used sheets subsequently collected. A used oil-containing composite sheet can be disposed of by combustion.

### Example 5

The composite board according to Example 1 has also been tested in the filtration of polluted water, such as run-off rain water and other drainage waters. For example in urban areas, as a result of traffic and industry, run-off rain waters are accumulated with heavy metals which may be carried to waterways. It is well known that peat possesses the ability to bind heavy metals. In the performed filtration experiments it has been observed that the retaining capacity of the composite board according to Example 1 is at least as good as that of natural peat, and, furthermore, the production of filtration structures by using the method of the invention is considerably easier compared with bulk peat. Microbial growth is able to attach on the surfaces of the ingredients of the composite structure, whereby micro-organisms are capable of removing e.g. nitrogen and phosphorus from the water. In addition, solids in the water will remain in the pores of the composite structure functioning as filter plate. The composite structure described in Example 1 thus functions both as physical, chemical and biological filtration material.

### INDUSTRIAL APPLICABILITY

Certain embodiments of the present invention are industrially applicable to manufacturing of growth media, thermal insulation boards, acoustic panels, oil absorption plates and biological water filtration plates.

### Abbreviations

PES polyester
PLA polylactate
PHA polyhydroxy alkanoate

### REFERENCE PUBLICATIONS

### Patent Publications

FI 122883 (B)
US 20090019765 (A1)
WO 2008065233 (A1)
FI 10169 (U1)

### Non-Patent Publications

www.konto.fi
www.angleitner-doa.at
www.zimmer-usa.com

1. A composite structure comprising in intimate mixture essentially through the whole composite structure:
peat fibers, peat particles, peat agglomerates, or mixtures thereof, that have been obtained from peat by fractionation or production from peat fines; and
polymer fibers,
wherein the composite structure has been heat-treated to bind the polymer fibers to each other and to stabilize the peat fibers, peat particles, peat agglomerates, or mixtures thereof in place in the composite structure.

2. The composite structure according to claim 1, wherein the composite structure is porous and non-layered throughout.

3. (canceled)

4. The composite structure according to claim 1, wherein the polymer fibers comprise polyester fibers.

5. The composite structure according to claim 1, wherein the polymer fibers comprise biodegradable or compostable polymers.

6. The composite structure according to claim 1, wherein the peat fibers, peat particles, peat agglomerates, or mixtures thereof comprise at least 50% of a dry weight of the composite structure.

7. The composite structure according to claim 1, further comprising a natural material, preferably selected from the group consisting of moss, pulp fiber, carbon, wood fiber, flax, reed canary grass, coconut, and hemp.

8. The composite structure according to claim 1, having a density of from 30 to 120 kg/m³.

9. The composite structure according to claim 1, wherein the composite structure is a growth medium or a part thereof.

10. The composite structure according to claim 1, wherein the composite structure comprises a member selected from the group consisting of a thermal insulation board, a sound insulation board, an acoustic panel, an oil absorption plate, a biological water filtration plate, and a part thereof.

11. A process for the production of a composite structure by air-laid forming, comprising:
forming a peat-polymer mixture between peat fibers, peat particles, peat agglomerates, or mixtures thereof and polymer fibers;
spreading the peat-polymer mixture as a layer on a screen; and
heat-treating the layer to bind the polymer fibers to each other and to stabilize the peat fibers, peat particles, peat agglomerates, or mixtures thereof in place.

12. The process according to claim 11, further comprising obtaining the peat fibers, peat particles, peat agglomerates, or mixtures thereof by fractionation from peat.

13. The process according to claim 11, wherein the composite structure comprises peat agglomerates, and wherein the peat agglomerates are produced from peat fines.

14. The process according to claim 11, further comprising, after the heat treating, pressing the heat-treated layer to a thickness of from 10 to 300 mm.

15. The process according to claim 11, wherein a density of the composite structure is from 30 to 120 kg/m³.

16. The process according to claim 11, wherein the composite structure is porous and non-layered throughout.

17. The process according to claim 11, wherein, prior to heat treatment, one or more of the group consisting of a wetting agent, fertilizer, humic acid, and lime are added to the peat fibers, peat particles, peat agglomerates, or mixtures thereof, polymer fibers, peat-polymer mixture, and/or layer.

18. The process according to claim 11, wherein the polymer fibers comprise polyester fibers.

19. The process according to claim 11, wherein a length of the polymer fibers is from 10 to 50 mm.

20. The process according to claim 11, wherein a proportion of polymer fibers in the peat-polymer mixture is from 5 to 50 wt.

21. The process according to claim 11, wherein the peat-polymer mixture further comprises a natural material selected from the group consisting of moss, pulp fiber, carbon, wood fiber, flax, reed canary grass, coconut, and hemp.

22. The process according to claim 11, wherein the heat treatment is carried out at a temperature that is maximally equal to an attachment temperature of the polymer fibers or their outer surface.

23. The process according to claim 11, wherein said composite structure comprises at least 50% of peat fibers, peat particles, peat agglomerates, or mixtures thereof based on a dry weight of the composite structure.

24. A composite structure obtained by a process according to claim 11.
